(19) United States
(12) Patent Application Publication
(10) Pub. No.: US 2026/0081479 A1
(43) Pub. Date: Mar. 19, 2026

(54) SYSTEM, TRANSMITTER, AND METHOD

(71) Applicant: Aeterlink Corp., Tokyo (JP)

(72) Inventors: Naoto KODATE, Tokyo (JP); Tomohiro KUBOUCHI, Tokyo (JP)

(73) Assignee: Aeterlink Corp., Tokyo (JP)

(21) Appl. No.: 19/396,378

(22) Filed: Nov. 21, 2025

Related U.S. Application Data
(63) Continuation-in-part of application No. PCT/JP2024/018065, filed on May 16, 2024.

(30) Foreign Application Priority Data
May 22, 2023 (JP) 2023-083948

(51) Int. Cl. H02J 50/80; H02J 50/40; H04L 5/00

(52) U.S. Cl. CPC H02J 50/80; H02J 50/40; H04L 5/0051

(57) ABSTRACT

A system including a plurality of transmitters configured to transmit a wireless signal for supplying power and an information processing apparatus configured to supply electric power for that transmission, wherein the plurality of transmitters are electrically connected in series with the apparatus in a daisy-chain connection, wherein at least one transmitter among the plurality includes a measuring means to measure at least one of a supply voltage and a supply current associated with the supplied electric power, wherein at least one of (i) a transmitter among the plurality of the transmitters or (ii) the information processing apparatus includes a determining means to determine whether at least one measured value satisfies a predetermined requirement.

### CROSS-REFERENCE TO RELATED APPLICATIONS

This application is a continuation-in-part of International Application No. PCT/JP2024/018065 filed on May 16, 2024, and claims priority from Japanese Patent Application No. 2023-083948 filed on May 22, 2023, the entire content of each are incorporated herein by reference.

### TECHNICAL FIELD

The present disclosure relates to a wireless power transfer system, a transmitter, and a method.

### BACKGROUND ART

In recent years, wireless power transfer (WPT) has been utilized in various fields. By employing WPT, in comparison with wired power transmission, it is possible to avoid issues such as the burden of wiring, wire breakage, and maintenance.

JP2014-223018A describes a system that supplies power to devices requiring power by means of microwave transmission.

### SUMMARY OF INVENTION

Aspect of non-limiting embodiments of the present disclosure relates to provide a technology that enables stable and scalable wireless power delivery using transmitters daisy-chained electrically in series, including measurement-based adequacy determination and notification of supply voltage and/or current against predetermined requirements, with optional single-cable distribution of electric power, a frequency reference, and data.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided a system including:
a plurality of transmitters configured to transmit a wireless signal for supplying power; and
an information processing apparatus configured to supply electric power for transmitting the wireless signal;
in which the plurality of transmitters are electrically connected in series with the information processing apparatus in a daisy-chain connection,
in which at least one transmitter among the plurality of transmitters comprises a measurement unit configured to measure at least one of a voltage and a current associated with the supply of the electric power,
in which at least one of (i) a transmitter among the plurality of transmitters or (ii) the information processing apparatus comprises a determination unit configured to determine whether at least one of the measured voltage and the measured current satisfies predetermined requirements, and
in which at least one of (i) a transmitter among the plurality of transmitters or (ii) the information processing apparatus comprises a notification unit for, when the predetermined requirements are not satisfied, notify information regarding a determination result to at least one of a user and the information processing apparatus.

### BRIEF DESCRIPTION OF DRAWINGS

Exemplary embodiment(s) of the present invention will be described in detail based on the following figures, wherein:

FIG. 1 is a diagram illustrating an overall configuration of a wireless power transmission (WPT) system 1 according to the present embodiment;

FIG. 2 is a block diagram illustrating an example configuration of a transmitter 100 and a receiver 200 shown in FIG. 1;

FIG. 3 is a block diagram illustrating an example configuration when a first information processing apparatus 300 and a transmitter 100 are connected;

FIG. 4 is a block diagram illustrating another example configuration when the first information processing apparatus 300 and the transmitter 100 are connected;

FIG. 5 is a block diagram illustrating another example configuration when the first information processing apparatus 300 and a transmitter 100A are connected;

FIG. 6 is a block diagram illustrating an example configuration in which a plurality of transmitters 100 are connected to the first information processing apparatus 300 via a cable 301;

FIG. 7 is a block diagram illustrating another example configuration when the first information processing apparatus 300 and the transmitter 100 are connected; and

FIG. 8 is a block diagram illustrating a basic hardware configuration of a computer 90.

### DESCRIPTION OF EMBODIMENTS

Hereinafter, embodiments of the present disclosure will be described with reference to the drawings. In all the drawings illustrating the embodiments, the same reference signs are assigned to common components, and repeated explanations are omitted. Note that the following embodiments are not intended to unduly limit the contents of the present disclosure recited in the claims. In addition, not all components shown in the embodiments are necessarily essential components of the present disclosure. Furthermore, each drawing is a schematic diagram and is not necessarily illustrated with strict accuracy.

### Outline

In a wireless power transmission (WPT) system including a plurality of transmitters that transmit a wireless signal for supplying power and an information processing apparatus that supplies power for transmitting the wireless signal, the plurality of transmitters are electrically connected in series with the information processing apparatus.

### <1. Overall Configuration Diagram of System>

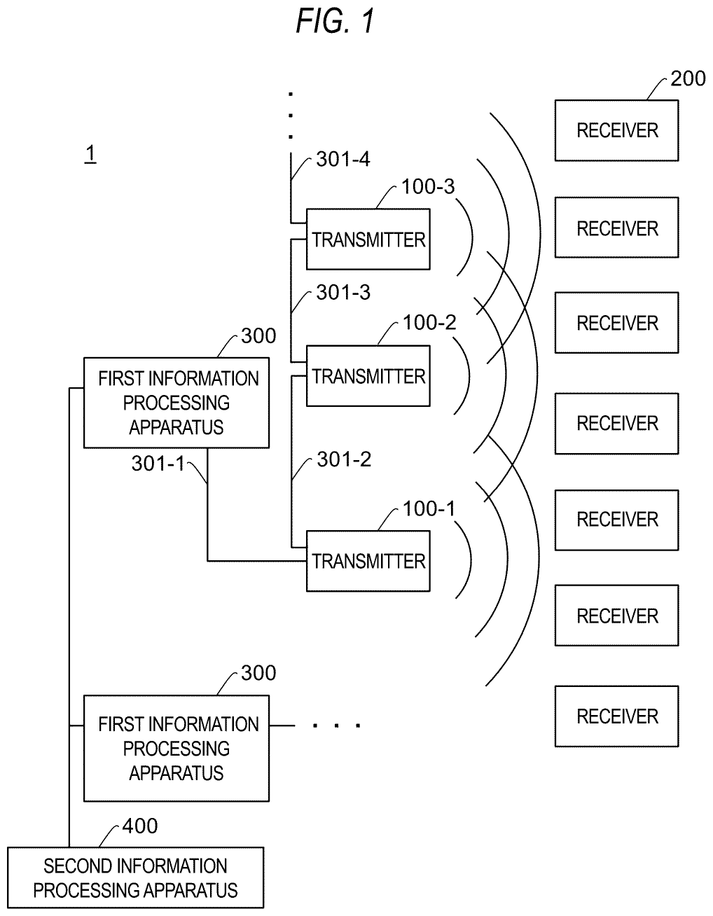

FIG. 1 is a diagram showing an overall configuration of a WPT system 1 according to the present embodiment.

As illustrated in FIG. 1, the WPT system 1 includes, for example, a transmitter 100, a receiver 200, a first information processing apparatus 300, and a second information processing apparatus 400. The WPT system 1 illustrated in FIG. 1 is utilized, for example, in a building or a factory. The transmitter 100 is electrically connected in series (daisy-chained) with the first information processing apparatus 300. That is, the transmitter 100 is connected to the first information processing apparatus 300 in a daisy-chain manner. Specifically, the transmitter 100-1 and the first information processing apparatus 300 are connected via a cable 301-1. The transmitter 100-1 and a transmitter 100-2 are connected via a cable 301-2. The transmitter 100-2 and a transmitter 100-3 are connected via a cable 301-3. Because the structures of the transmitters 100-1 to 100-3 are substantially the same, when distinction is unnecessary, they will be collectively referred to as “the transmitter 100”. The connection between the first information processing apparatus 300 and the second information processing apparatus 400 may be either wired or wireless.

In FIG. 1, an example in which the WPT system 1 includes three transmitters 100 is illustrated; however, the number of transmitters 100 included in the WPT system 1 is not limited to three. The transmitters 100 included in the WPT system 1 may be two or fewer, or four or more.

In FIG. 1, an example in which the WPT system 1 includes seven receivers 200 is illustrated; however, the number of receivers 200 included in the WPT system 1 is not limited to seven. The receivers 200 included in the WPT system 1 may be six or fewer, or eight or more.

In the present embodiment, the transmitter 100 is a (power) transmitter in the sense of transmitting power wirelessly, and similarly, the receiver 200 is a (power) receiver in the sense of receiving power wirelessly. As described later, the receiver 200 may transmit, for example, information regarding a state of the receiver 200 or information regarding measurement results by a sensor as a data signal to the transmitter 100, and the transmitter 100 may receive such a data signal. In this case, the transmitter 100 functions as a receiver that receives a data signal, and the receiver 200 functions as a transmitter that transmits a data signal.

In FIG. 1, an example in which the WPT system 1 includes two first information processing apparatuses 300 is illustrated; however, the number of first information processing apparatuses 300 included in the WPT system 1 is not limited to two. The first information processing apparatuses 300 included in the WPT system 1 may be one, or three or more.

The transmitter 100 transmits, for example, a wireless signal for supplying power, or a data signal, to the receiver 200. The transmitter 100 transmits, for example, the wireless signal for supplying power to the receiver 200 by means of radio waves in the 920 MHz band. The transmitter 100 transmits, for example, the data signal to the receiver 200 by means of radio waves in the 2.4 GHz band. The transmitter 100 may also transmit the data signal by means of radio waves in the 920 MHz band.

The transmitter 100 may supply power to one receiver 200 or to a plurality of receivers 200. The transmitter 100 may transmit a data signal to one receiver 200 or to a plurality of receivers 200. The transmitter 100 may transmit the same data signal as another transmitter 100, or may transmit a data signal different from that of another transmitter 100. The transmitter 100 may transmit, for example, a predetermined command signal as a data signal to the receiver 200, or may transmit a predetermined signal as a data signal to the receiver 200.

The transmitter 100 receives, for example, a data signal transmitted from the receiver 200. The transmitter 100 may receive a data signal transmitted from one receiver 200, or may receive data signals transmitted from a plurality of receivers 200. The transmitter 100 transmits a data signal transmitted from the receiver 200 to the first information processing apparatus 300. The transmitter 100 transmits information regarding a state of the transmitter 100 to the first information processing apparatus 300. A signal transmitted from the transmitter 100 is conveyed to the first information processing apparatus 300 via the plurality of transmitters 100 that are daisy-chained.

The receiver 200 receives, for example, the wireless signal for supplying power, or a data signal, transmitted from the transmitter 100. When the receiver 200 includes, for example, a power storage unit, the receiver 200 converts the wireless signal for supplying power transmitted from the transmitter 100 into electric power and stores the converted electric power in the power storage unit. When the receiver 200 includes, for example, a predetermined sensor, the receiver 200 converts the wireless signal for supplying power transmitted from the transmitter 100 into electric power and drives the sensor by the converted electric power.

The receiver 200 transmits, for example, information regarding a state of the receiver 200 or information regarding measurement results by the sensor as a data signal to the transmitter 100.

The first information processing apparatus 300 is an information processing apparatus that monitors operations of the transmitters 100 and the receivers 200 accommodated in the WPT system 1. For example, based on information regarding states of the transmitters 100 and the receivers 200 that is transmitted from the transmitter 100, the first information processing apparatus 300 determines whether the transmitter 100 or the receiver 200 is in a predetermined state. When it is determined to be in the predetermined state, the first information processing apparatus 300 transmits predetermined information to the second information processing apparatus 400.

The first information processing apparatus 300 also accumulates information regarding the transmitters 100 and the receivers 200 accommodated in the WPT system 1. For example, the first information processing apparatus 300 stores, in a storage unit provided in the first information processing apparatus 300, information regarding states of the transmitters 100 and the receivers 200 that is transmitted from the transmitter 100.

The first information processing apparatus 300 also supplies electric power to the connected transmitter 100. Specifically, for example, the first information processing apparatus 300 supplies electric power of a predetermined magnitude to the transmitter 100-1 via the cable 301-1. The amount of supplied electric power may be predetermined, or may vary according to the number of connected transmitters. Electric power supplied from the first information processing apparatus 300 to the transmitter 100-1 is sequentially conveyed to the transmitter 100-2 and the transmitter 100-3 that are daisy-chained.

The first information processing apparatus 300 also controls operations of the transmitters 100 accommodated in the WPT system 1. For example, the first information processing apparatus 300 transmits predetermined instructions or information to the transmitter 100. The predetermined instructions or information transmitted from the first information processing apparatus 300 include, for example, a transmission timing of the wireless signal for supplying power, turning on/off of the transmitter 100, monitoring of a state of the transmitter 100, resetting of a state of the transmitter 100, acquisition of a version of the transmitter 100, acquisition of sensor data received by the transmitter 100, transmission of a test command, and the like. These instructions or information may be transmitted by predetermined commands, for example.

Specifically, for example, the first information processing apparatus 300 designates at least one of the transmitters 100-1 to 100-3 and transmits, via the cable 301-1, to the transmitter 100-1 a data signal including predetermined instructions or information. That is, although different conductors are used for transmission, the first information processing apparatus 300 transmits electric power and a data signal by means of a single cable. The data signal transmitted from the first information processing apparatus 300 to the transmitter 100-1 is conveyed, via the daisy-chained transmitter 100-2 and transmitter 100-3, to the designated transmitter 100. The first information processing apparatus 300 may transmit, without specifying a destination, a data signal addressed to any transmitter 100 to the transmitter 100-1.

The first information processing apparatus 300 also controls operations of the second information processing apparatus 400.

The second information processing apparatus 400 is, for example, an information processing apparatus operated by an administrator of the WPT system 1. When the second information processing apparatus 400 receives, from the first information processing apparatus 300, a notification that the transmitter 100, the receiver 200, or both are in a predetermined state, the second information processing apparatus 400 presents to a user that the transmitter 100, the receiver 200, or both are in the predetermined state.

The second information processing apparatus 400 also analyzes information regarding states of the transmitters 100 and the receivers 200 that is accumulated in the first information processing apparatus 300, and presents predetermined information to the user.

The predetermined information includes, for example:
information regarding placement of the transmitters 100;
information regarding placement of the receivers 200;
information regarding power consumption; and
information regarding amount of electric power.

### <1.1 Configurations of Transmitter and Receiver>

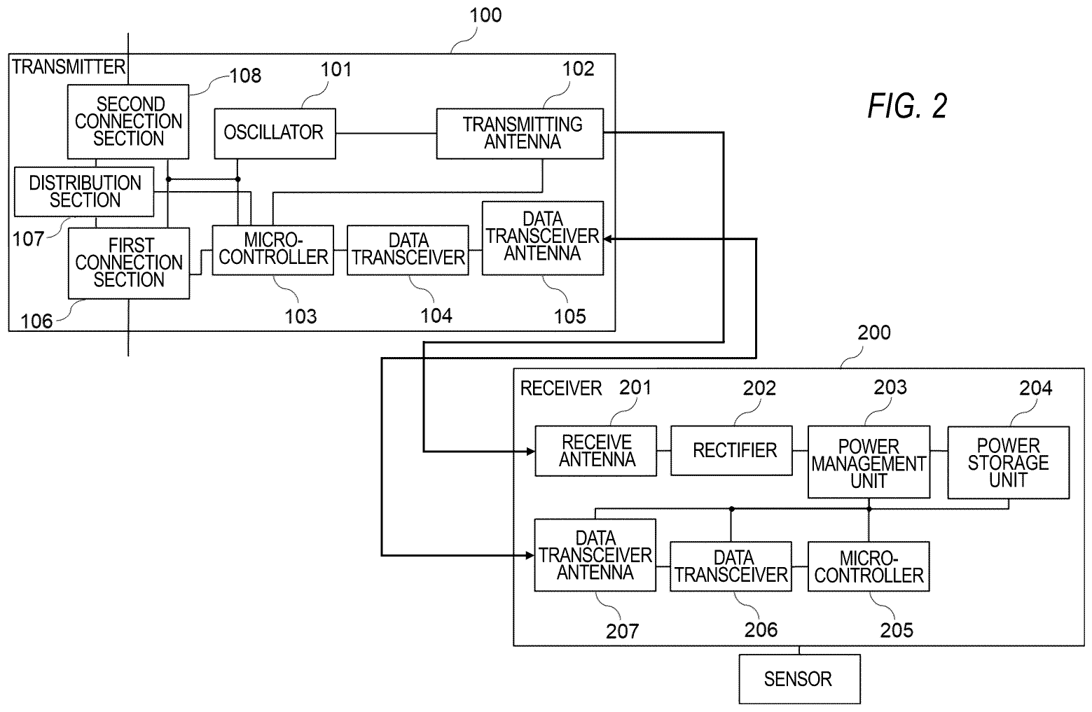

FIG. 2 is a block diagram showing an example of a configuration of the transmitter 100 and the receiver 200 shown in FIG. 1. As shown in FIG. 2, the transmitter 100 and the receiver 200 are spaced apart from each other by, for example, a predetermined interval. For example, the transmitter 100 and the receiver 200 are installed spaced apart from each other by a distance of several meters. Specifically, for example, the transmitter 100 is fixedly installed at an elevated position indoors, such as on the ceiling or at a predetermined high position provided on a wall. The receiver 200 is installed on a predetermined device indoors or placed near a device requiring power supply. Additionally, the receiver 200 may be carried by the user. The transmitter 100 transmits the power supply signal to the receiver 200 by radio waves in the 920 MHz band, for example. The receiver 200 converts the power supply signal transmitted from the transmitter 100 into power, and stores the converted power or supplies the converted power to a predetermined device.

The transmitter 100 includes, for example, an oscillator 101, a transmitting antenna 102, a microcontroller (controller) 103, a data transceiver 104, a data transceiver antenna 105, a first connection section 106, a distribution section 107, and a second connection section 108. The oscillator 101, the microcontroller 103, the data transceiver 104, the data transceiver antenna 105, the distribution section 107, or at least some combination thereof may be, for example, mounted on a PCB (printed circuit board). The transmitter 100 may include a power storage unit that stores supplied electric power.

The oscillator 101 is driven by a part of the electric power received at the first connection section 106, and oscillates a signal in a predetermined frequency band, for example in the 920-MHz band. The oscillated signal may, as needed, be amplified and have unnecessary frequency components removed.

The transmitting antenna 102 is formed so as to efficiently transmit, for example, radio waves in the 920-MHz band. The transmitting antenna 102 radiates the signal oscillated by the oscillator 101 as the wireless signal for supplying power.

The microcontroller 103 controls operations of the transmitter 100. The microcontroller 103 is implemented, for example, by a semiconductor device equipped with an ARM processor. The microcontroller 103 controls transmission of radio waves by the transmitting antenna 102 based on, for example, a data signal supplied from the first information processing apparatus 300 disposed at an upstream stage or from the transmitter 100.

The microcontroller 103 also determines whether electric power supplied from the first information processing apparatus 300 disposed at an upstream stage or from the transmitter 100 satisfies predetermined requirements. Specifically, for example, electric power supplied from the first information processing apparatus 300 disposed at an upstream stage or from the transmitter 100 is measured by a measurement unit (not shown) provided in the transmitter 100. The measurement unit may measure an amount of current or may measure a voltage. The microcontroller 103 determines whether the measurement result satisfies predetermined requirements. When it is determined that the measurement result does not satisfy the predetermined requirements, the microcontroller 103 presents the determination result to a user.

Specifically, for example, a power value capable of driving the transmitter 100 is set, and the microcontroller 103 determines whether the measurement result is equal to or greater than this power value. More specifically, for example, when the transmitter 100 transmits a 1-W wireless signal for supplying power to the receiver 200, about 6 W of electric power is required in the transmitter 100. The microcontroller 103 determines whether the measurement result is equal to or greater than 6 W. When the measurement result is less than the set power value, the microcontroller 103 presents the determination result to a user.

The measurement unit may include a voltage monitoring integrated circuit (so-called supervisor IC), a window comparator, or an analog-to-digital converter (ADC) that monitors a voltage on a power supply line. The measurement unit compares the voltage on the power supply line with a reference voltage generated internally or externally and detects a state in which the voltage falls below a predetermined threshold. The monitored voltage may be scaled by a voltage divider circuit.

To suppress false detection, the measurement unit may have hysteresis characteristics (upper and lower thresholds) or a response delay. Specifically, a configuration may be adopted in which a shortage state is determined only when the state in which the voltage is below the lower threshold continues for a predetermined time (debounce time).

The measurement unit may include a current detection element. The current detection element measures a current supplied to the transmitter 100 by using, for example, a shunt resistor, a Hall element, or a current sense amplifier (CSA). The measurement unit monitors a current response at a start-up request or at a load transient and detects a state of insufficient supply capability when a state below a predetermined threshold with respect to a predetermined inrush-current profile continues for a predetermined time.

The measurement unit may successively sample a voltage or a current at a predetermined period by the ADC and apply a digital filter such as a moving average, an exponential weighted moving average, or a median filter to the sample sequence to reduce the influence of momentary variations due to noise. The microcontroller (MCU) 103 may estimate a declining tendency of supply capability based on a time-series history of the filtered values, the declining tendency being caused by, for example, an increase in internal impedance, an increase in cable length, or an increase in connection resistance.

The measurement unit may adjust determination conditions according to a position in a daisy-chain connection. Specifically, thresholds, response delay, or debounce time that are predetermined may be set differently according to an upstream/downstream relationship of the transmitter 100, a hop count, or the presence or absence of a termination resistor at an end. The MCU 103 switches the determination conditions for the measurement results dynamically based on the position information.

The MCU 103 may integrate results of voltage monitoring and current monitoring by a logical OR, a logical AND, or weighted scoring. When insufficient supply capability is detected, the MCU 103 may gradually reduce at least one of a transmission output, a duty ratio, and a transmission timing of the wireless signal for supplying power of the transmitter 100, and after a predetermined number of retries, may generate a shut-off signal or a reset signal and notify a user and/or the first information processing apparatus 300.

The measurement unit may include a calibration function. Specifically, zero-point correction and gain correction may be performed at shipment or at on-site installation, and a temperature-dependent correction coefficient may be applied. The MCU 103 stores measurement values, determination results, determination times, identification information of the transmitter 100, and the like, and transmits them to the first information processing apparatus 300 under predetermined conditions.

The transmitter 100 may include a light-emitting unit and/or a sound-emitting unit. The microcontroller 103 presents the determination result visually by the light-emitting unit or aurally by the sound-emitting unit. When the determination result is presented, a user removes the transmitter 100 connected at the end of the daisy-chain connection. Alternatively, when the determination result is presented, the user operates, for example, the first information processing apparatus 300 to increase a supply amount of electric power. The operation of the first information processing apparatus 300 may be input directly at the first information processing apparatus 300 or may be input from an operation terminal possessed by the user.

The measurement unit may measure electric power received at the first connection section 106. In this case, for example, a predetermined electric power according to the number of connected units is set, and the microcontroller 103 determines whether the measurement result is equal to or greater than this power value.

The data transceiver 104 performs processing such as analog conversion of digital data and modulation of analog data. The data transceiver 104 also performs processing such as demodulation of a data signal received by the data transceiver antenna 105 and digitization of the demodulated data. The data transceiver 104 extracts, for example, a predetermined signal from a data signal received by the data transceiver antenna 105, converts it into digital data, and transmits the digital data to the microcontroller 103.

The data transceiver antenna 105 is formed so as to efficiently transmit and receive, for example, radio waves in the 2.4-GHz band. The data transceiver antenna 105 radiates a data signal supplied from the data transceiver 104. The data transceiver antenna 105 also receives a data signal transmitted from the receiver 200.

The first connection section 106 connects to, for example, the first information processing apparatus 300 disposed at an upstream stage or to a transmitter 100 (a device disposed at an upstream stage). Specifically, for example, the first connection section 106 is a connection terminal connected to a device disposed at an upstream stage via a cable 301. The first connection section 106 receives, via the cable 301, electric power or a data signal supplied from the device disposed at an upstream stage. A part of the electric power received at the first connection section 106 is supplied to a measurement unit (not shown) for electric power, and after a power value is measured, the electric power is used in the transmitter 100. When the transmitter 100 includes a power storage unit, after the power value is measured, electric power may be supplied to the power storage unit. Electric power reduced by an amount used in the transmitter 100 is output to the second connection section 108. A data signal received at the first connection section 106 is output to the distribution section 107.

The first connection section 106 also transmits, to a device disposed at an upstream stage via the cable 301, a data signal received by the second connection section 108. The first connection section 106 also transmits, to a device disposed at an upstream stage via the cable 301, a data signal output from the microcontroller 103.

The distribution section 107 distributes, for example, a data signal output from the first connection section 106. The distribution section 107 outputs, for example, the distributed data signal to the microcontroller 103. The distribution section 107 outputs, for example, the data signal that is the source of the distribution to the second connection section 108.

The second connection section 108 connects to, for example, a transmitter 100 disposed at a downstream stage. Specifically, for example, the second connection section 108 is a connection terminal connected to a transmitter 100 disposed at a downstream stage via the cable 301. The second connection section 108 transmits, for example, electric power output from the first connection section 106 and a data signal output from the distribution section 107 to the transmitter 100 disposed at the downstream stage via the cable 301.

The second connection section 108 also receives, via the cable 301, a data signal supplied from the transmitter 100 disposed at the downstream stage. The second connection section 108 outputs the received data signal to the first connection section 106.

The receiver 200 includes, for example, a receive antenna 201, a rectifier 202, a power management unit (PMU) 203, a power storage unit 204, a microcontroller 205, a data transceiver 206, and a data transceiver antenna 207. The receive antenna 201, the rectifier 202, the power management unit 203, the power storage unit 204, the microcontroller 205, the data transceiver 206, the data transceiver antenna 207, or at least some combination thereof may be, for example, mounted on a PCB or an FPC (flexible printed circuit board).

The receive antenna 201 is formed so as to efficiently receive, for example, radio waves in the 920-MHz band. The receive antenna 201 receives the wireless signal for supplying power radiated from the transmitting antenna 102.

The rectifier 202 rectifies a radio wave received as the wireless signal for supplying power and converts it into a direct-current voltage.

The power management unit 203 manages the direct-current voltage. For example, the power management unit 203 controls a charging voltage based on the direct-current voltage. By controlling the charging voltage, the power management unit 203 charges the power storage unit 204. The power management unit 203 also supplies the direct-current voltage to a connected component, for example, when electric power of a predetermined capacity or more is stored in the power storage unit 204.

The power management unit 203 also causes electric power stored in the power storage unit 204 to be discharged in response to control from the microcontroller 205.

The power storage unit 204 stores electric power in response to an instruction from the power management unit 203. The power storage unit 204 is implemented, for example, by a battery or a capacitor. The power storage unit 204 also discharges stored electric power in response to an instruction from the power management unit 203.

The microcontroller 205 controls operations of the receiver 200. The microcontroller 205 is driven by the direct-current voltage supplied from the power management unit 203 or by electric power stored in the power storage unit 204. The microcontroller 205 controls the power management unit 203 and causes electric power stored in the power storage unit 204 to be discharged.

Various sensors are connectable to the receiver 200. For example, a heat sensor, a temperature sensor, a light sensor, a humidity sensor, and a vibration sensor are connected to the receiver 200. A sensor connected to the receiver 200 is driven, for example, by the direct-current voltage supplied from the power management unit 203 or by electric power discharged from the power storage unit 204. The microcontroller 205 continuously or intermittently monitors, for example, a voltage value at a predetermined portion of the receiver 200, a status of a sensor connected to the receiver 200, and information detected by the sensor. The microcontroller 205 transmits, as digital data, the voltage value at a predetermined portion of the receiver 200, the status of a sensor connected to the receiver 200, and information detected by the sensor to the data transceiver 206. The sensor may be built into the receiver 200.

The data transceiver 206 performs processing such as analog conversion of digital data supplied from the microcontroller 205 and modulation of analog data. The data transceiver 206 also performs processing such as demodulation of a data signal received by the data transceiver antenna 207 and digitization of the demodulated data. The data transceiver 206 is driven, for example, by the direct-current voltage supplied from the power management unit 203 or by electric power discharged from the power storage unit 204.

The data transceiver antenna 207 is formed so as to efficiently transmit and receive, for example, radio waves in the 2.4-GHz band. The data transceiver antenna 207 radiates a data signal supplied from the data transceiver 206. The data transceiver antenna 207 also receives a data signal transmitted from the transmitter 100. For example, the data transceiver antenna 207 is driven by the direct-current voltage supplied from the power management unit 203 or by electric power discharged from the power storage unit 204.

### <2 Daisy-Chain Connection>

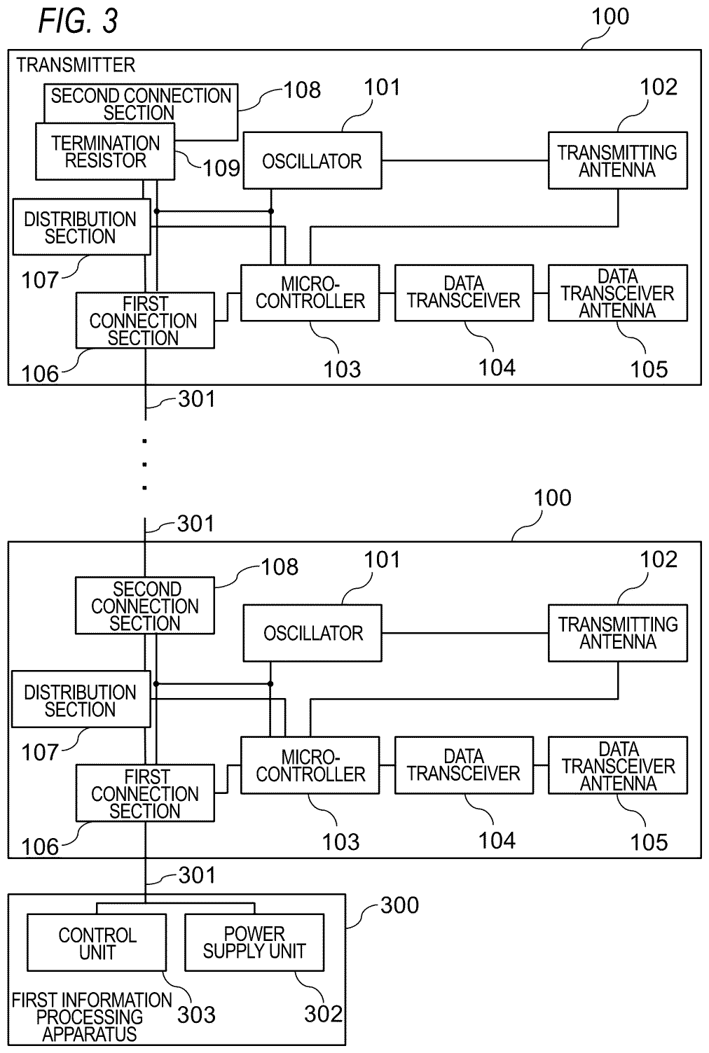

FIG. 3 is a block diagram illustrating an example configuration when the first information processing apparatus 300 and the transmitter 100 are connected. In the diagram shown in FIG. 3, a plurality of transmitters 100 are daisy-chained to the first information processing apparatus 300. The first information processing apparatus 300 and the transmitter 100, and the transmitters 100 to each other, are connected by a cable 301.

The first information processing apparatus 300 includes a power supply unit 302. Specifically, for example, the power supply unit 302 includes a converter that converts an alternating-current voltage into a direct-current voltage and supplies the direct-current voltage to the connected transmitter 100. Electric power supplied from the power supply unit 302 may be predetermined, may vary according to the number of connected transmitters, or may vary according to an operation from a user. Electric power supplied from the power supply unit 302 may also be varied according to control by a control unit 303. When a direct-current voltage is supplied to the first information processing apparatus 300, the power supply unit 302 need not include the function of a converter.

Electric power supplied from the first information processing apparatus 300 is supplied to the transmitters 100 that are daisy-chained. In each transmitter 100, a power level of the supplied electric power is measured. The microcontroller 103 determines, based on the measured power level, whether the supplied electric power is capable of driving the transmitter 100. When the supplied electric power is less than a power level capable of driving the transmitter 100, the microcontroller 103 notifies a user to that effect.

The transmitter 100 includes a termination resistor 109. In FIG. 3, it is described that only the transmitter 100 connected at the end includes the termination resistor 109, but all the transmitters 100 may include the termination resistor 109. In the transmitter 100 connected at the end, an output destination of electric power output from the first connection section 106 is switched from the second connection section 108 to the termination resistor 109.

The first information processing apparatus 300 includes the control unit 303. The control unit 303 transmits predetermined instructions or information as a data signal to the transmitter 100.

In the description shown in FIGS. 2 and 3, a case is described in which the transmitter 100 includes a light-emitting unit or a sound-emitting unit and the transmitter 100 determines whether sufficient electric power is supplied to the transmitter 100 and presents a notification to a user according to the determination result. However, the first information processing apparatus 300 may present to a user a notification according to the determination result.

Specifically, for example, the microcontroller 103 included in any one of the transmitters 100 that are daisy-chained transmits, from the first connection section 106, the determination result to the first information processing apparatus 300 as a transmission destination. In this case, the microcontroller 103 adds, for example, identification information of its own device. The control unit 303 analyzes received information and specifies the transmitter 100 that transmitted the data. The control unit 303 presents to a user that electric power is insufficient in the specified transmitter 100. The control unit 303 notifies a user that electric power is insufficient using, for example, a predetermined notification function possessed by the first information processing apparatus 300. The control unit 303 may notify, via a communication line, a terminal possessed by a user that electric power is insufficient. The control unit 303 may also increase electric power supplied from the power supply unit 302 so that electric power can be supplied to the transmitter 100 in which electric power is insufficient.

In the description shown in FIGS. 2 and 3, a case is described in which the transmitter 100 determines whether sufficient electric power is supplied to the transmitter 100. However, the first information processing apparatus 300 may perform a determination regarding supply of electric power. For example, the microcontroller 103 may transmit, from the first connection section 106 with the first information processing apparatus 300 as a transmission destination, a measurement result by a measurement unit. In this case, the microcontroller 103 adds, for example, identification information of its own device. The control unit 303 analyzes received information and specifies the transmitter 100 that transmitted the data. The control unit 303 determines whether the measurement result satisfies predetermined requirements. When the measurement result does not satisfy the predetermined requirements, the control unit 303 presents to a user that electric power is insufficient in the specified transmitter 100. The control unit 303 may also increase electric power supplied from the power supply unit 302 so that electric power can be supplied to the transmitter 100 in which electric power is insufficient.

In the example shown in FIG. 3, a case has been described in which the termination resistor 109 is provided in the transmitter 100. However, the termination resistor 109 need not be provided in the transmitter 100. For example, a termination resistor 304 may be connected to the second connection section 108 of the transmitter 100.

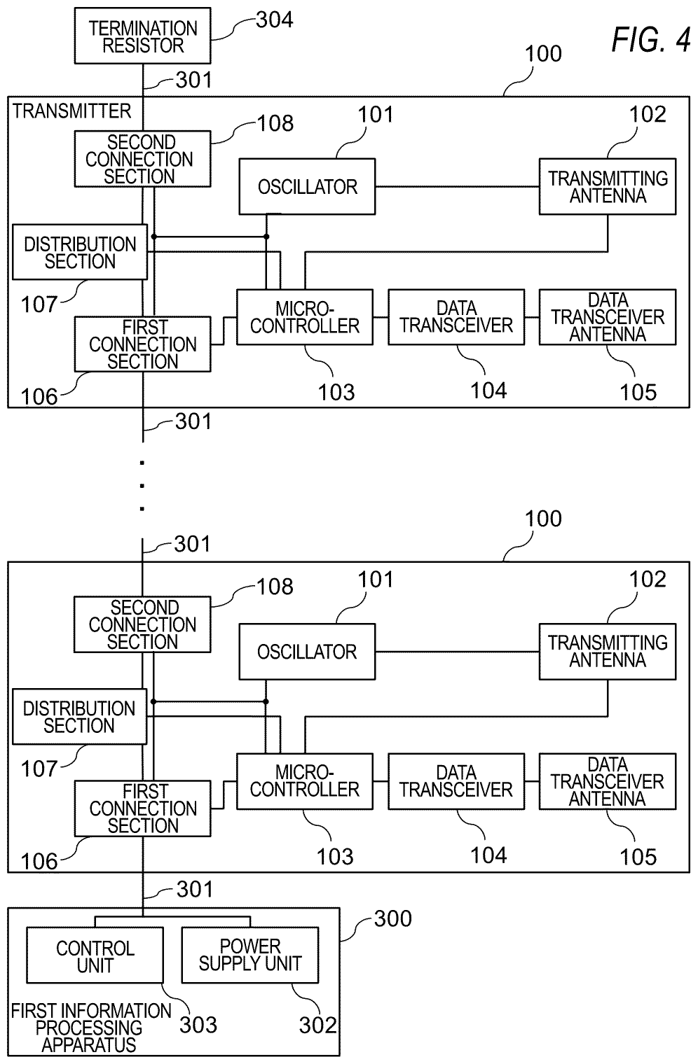

FIG. 4 is a block diagram illustrating another example configuration when the first information processing apparatus 300 and the transmitter 100 are connected. In the diagram shown in FIG. 4, the termination resistor 304 is connected to the second connection section 108 of the transmitter 100 connected at the end of the daisy-chain connection.

As described above, in the above embodiment, the system 1 includes the plurality of transmitters 100 that transmit a wireless signal for supplying power and the first information processing apparatus 300 that supplies electric power for transmitting the wireless signal. The plurality of transmitters 100 are electrically connected in series to the first information processing apparatus 300. Accordingly, it is unnecessary to provide a power supply line for supplying power to each transmitter 100. Since daisy-chain connection tends to result in insufficient electric power, a device with high power consumption is less likely to be connected. In the present embodiment, devices with high power consumption such as the transmitters 100 are connected, but the electric power consumed in the respective transmitters 100 is the same. In addition, in the transmitters 100 that form a power supply area, a possibility that power consumption suddenly fluctuates is low. Therefore, although the plurality of transmitters 100 are daisy-chained, electric power can be stably supplied to each transmitter 100. Therefore, wiring for supplying power individually to the respective transmitters 100 is unnecessary.

Accordingly, in the system 1 according to the present embodiment, when a power supply area is formed by the plurality of transmitters, a burden for constructing a power supply system can be reduced.

In addition, in the above embodiment, at least one of the plurality of transmitters 100 is connected to the first information processing apparatus 300 and to another transmitter 100, receives electric power supplied from the first information processing apparatus 300, and supplies at least a part of the received electric power to the other connected transmitter 100. At least one of the plurality of transmitters 100 is connected in a daisy-chain manner among the transmitters 100, receives electric power supplied from an upstream transmitter 100, and supplies at least a part of the received electric power to a downstream transmitter 100. In this way, daisy-chain connection of the transmitters 100 to the first information processing apparatus 300 is implemented.

In addition, in the above embodiment, the plurality of transmitters 100 transmit a wireless signal by using a part of electric power supplied from the first information processing apparatus 300 or from the upstream transmitter 100, and supply at least a part of remaining electric power to the downstream transmitter 100. In this way, individual power supply wiring to the transmitters 100 becomes unnecessary.

In addition, in the above embodiment, at least the transmitter 100 connected at the end of the daisy-chain among the plurality of transmitters 100 includes a termination resistor. In this way, the transmitters 100 that are daisy-chained can be driven stably.

In addition, in the above embodiment, the transmitter 100 includes a measurement unit that measures a power level of the supplied electric power, the microcontroller 103 that determines whether the measured power level satisfies predetermined requirements, and means for, when not satisfied, notifying information regarding the determination result to at least one of a user and the first information processing apparatus 300. In this way, when the supplied electric power is insufficient, it is possible to notify the user or the first information processing apparatus 300 that the electric power is insufficient.

In addition, in the above embodiment, the transmitter 100 includes a measurement unit that measures a power level of the supplied electric power and means for notifying information regarding the measured power level to the first information processing apparatus 300. The first information processing apparatus 300 includes the control unit 303 that determines, based on information regarding the power level, whether electric power supplied to the transmitter 100 satisfies predetermined requirements. In this way, the first information processing apparatus 300 can grasp the transmitter 100 in which electric power is insufficient.

### Modified Example

In the above embodiment, the transmitter 100 includes the oscillator 101 and is configured to oscillate a signal in a predetermined frequency band using electric power supplied from the first information processing apparatus 300. However, the transmitter 100 may not include the oscillator 101 and may receive a reference signal of frequency from the first information processing apparatus 300.

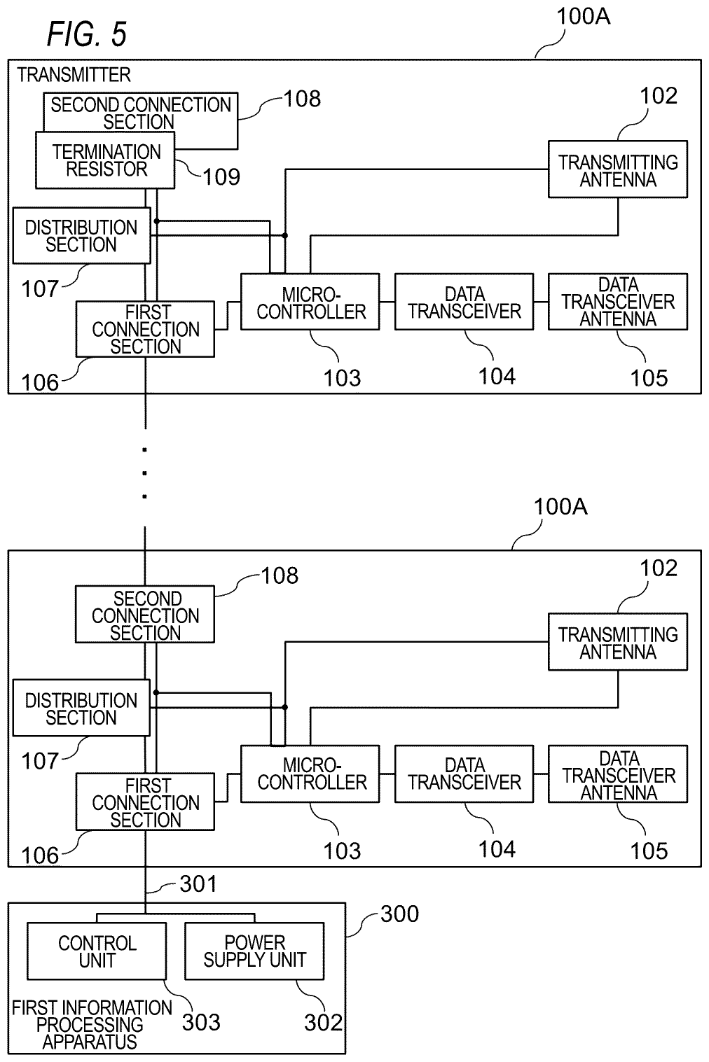

FIG. 5 is a block diagram illustrating another example configuration when the first information processing apparatus 300 and a transmitter 100A are connected. In the diagram shown in FIG. 5, a plurality of transmitters 100A are daisy-chained to the first information processing apparatus 300. The first information processing apparatus 300 and the transmitter 100A, and the transmitters 100A to each other, are connected by the cable 301.

The first information processing apparatus 300 includes the control unit 303. The control unit 303 transmits predetermined instructions or information as a data signal to the transmitter 100A. The control unit 303 also transmits a reference signal of frequency to the transmitter 100A.

The first connection section 106 connects to, for example, the first information processing apparatus 300 disposed at an upstream stage or to a transmitter 100A (a device disposed at an upstream stage). The first connection section 106 receives, for example, electric power, a data signal, or a reference signal supplied from the device disposed at the upstream stage via the cable 301. A part of electric power received at the first connection section 106 is supplied to a measurement unit (not shown) for electric power, and after a power value is measured, the electric power is used in the transmitter 100A. Electric power reduced by an amount used in the transmitter 100A is output to the second connection section 108. The data signal and the reference signal received at the first connection section 106 are output to the distribution section 107.

The distribution section 107 distributes, for example, a data signal output from the first connection section 106. The distribution section 107 outputs, for example, the distributed data signal to the microcontroller 103. The distribution section 107 outputs, for example, the data signal that is the source of the distribution to the second connection section 108. The distribution section 107 distributes, for example, a reference signal output from the first connection section 106. The distribution section 107 outputs, for example, the distributed reference signal to the transmitting antenna 102. The reference signal may, as needed, be amplified and have unnecessary frequency components removed and then be output to the transmitting antenna 102. The distribution section 107 outputs, for example, the reference signal that is the source of the distribution to the second connection section 108.

The second connection section 108 connects to, for example, a transmitter 100A disposed at a downstream stage. The second connection section 108 transmits, for example, electric power output from the first connection section 106, a data signal output from the distribution section 107, and a reference signal output from the distribution section 107 to the transmitter 100A disposed at the downstream stage via the cable 301.

The second connection section 108 also receives, via the cable 301, a data signal supplied from the transmitter 100A disposed at the downstream stage. The second connection section 108 outputs the received data signal to the first connection section 106.

In this way, by transmitting a reference signal of frequency from the first information processing apparatus 300 to the transmitter 100A, it is possible to unify a frequency of the wireless signal for supplying power radiated from the transmitter 100A without providing an oscillator in the transmitter 100A.

Even when a reference signal of frequency is transmitted from the first information processing apparatus 300, the transmitter 100 may include the oscillator 101. In this case, for example, a frequency of the reference signal is 10 MHz, and the oscillator 101 oscillates a 920-MHz signal based on the reference signal.

In the above embodiment, a case is described in which one transmitter 100 is connected to the first information processing apparatus 300 by the cable 301. However, the transmitter 100 connected to the first information processing apparatus 300 by the cable 301 is not limited to one. The first information processing apparatus 300 may be connected to a plurality of transmitters 100 that are connected in a daisy-chain manner.

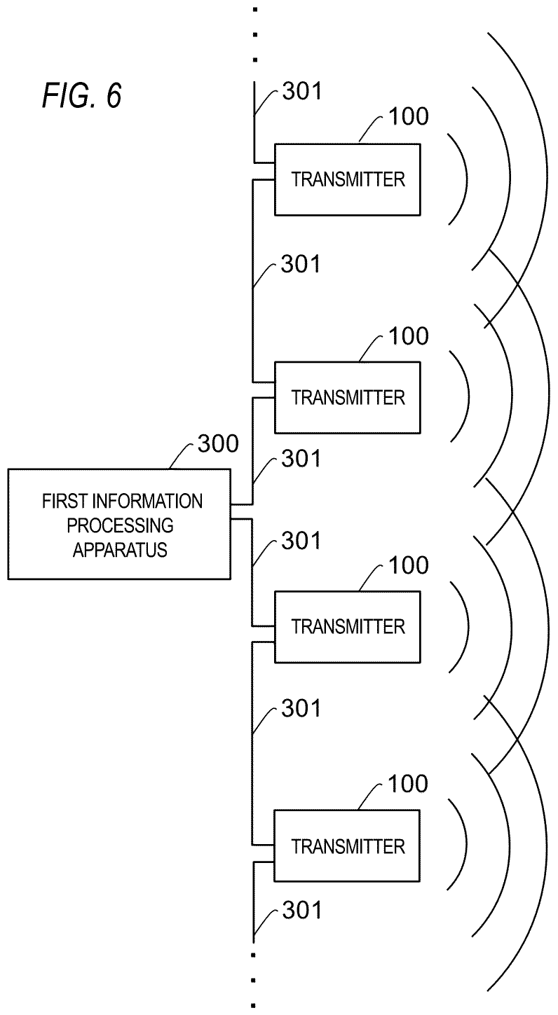

FIG. 6 is a block diagram illustrating an example configuration in which a plurality of transmitters 100 are connected to the first information processing apparatus 300 by the cable 301. In the diagram shown in FIG. 6, two transmitters 100 are connected to the first information processing apparatus 300. The number of transmitters 100 connectable to one chain is limited based on the amount of electric energy supplied from the first information processing apparatus 300. However, by making the number of chains a plurality, it is possible to increase the number of transmitters 100 that can be connected.

In the above embodiment, a case is described in which the microcontroller 103 or the control unit 303 determines whether a power level of electric power supplied to the transmitter 100 satisfies predetermined requirements. The predetermined requirements in this case may be stepwise requirements. Specifically, for example, a first threshold value and a second threshold value may be set based on the power level of electric power. For example, the first threshold value represents a minimum necessary power level to drive the transmitter 100. The second threshold value represents, for example, a power level higher than the first threshold value. The microcontroller 103 or the control unit 303 presents to a user that electric power is insufficient for the supplied electric power when a measurement value is less than the first threshold value. The microcontroller 103 or the control unit 303 presents to a user that there is a high possibility that electric power will be insufficient for the supplied electric power when a measurement value is equal to or greater than the first threshold value and less than the second threshold value.

In the above embodiment, application to the so-called WPT system 1 in which transmission power consisting of an alternating-current signal is wirelessly transmitted from the transmitter 100 to the receiver 200 has been described, but application to a system that supplies electric power to the receiver 200 by another method is of course possible. Since such systems are known, detailed description is omitted, but examples include a system that sends out electric power generated by solar power generation to the receiver 200 regardless of whether the transmission is wired or wireless, and a system that sends out electric power to the receiver 200 by laser light regardless of whether the transmission is wired or wireless. In addition, it is applicable to a configuration in which vibration or sound is applied to the receiver 200 and the receiver 200 converts power of vibration or the like into electric power. In addition, application is of course possible to a system using a known contactless power supply technology other than wireless reception of transmission power consisting of an alternating-current signal, for example a system using a contactless power supply technology by a magnetic-field coupling method.

In the above embodiment, a case is described in which electric power is supplied from the first information processing apparatus 300, but a supply source of electric power is not limited to the first information processing apparatus 300 alone. The transmitters 100 are daisy-chained, and a power supply line may be connected to at least one transmitter 100 that is daisy-chained. Electric power is supplied from the transmitter 100 to which the power supply line is connected to the transmitters 100 that are daisy-chained. The transmitter 100 to which the power supply line is connected may be a first transmitter 100 that is daisy-chained, may be a last transmitter 100, or may be an intermediate transmitter 100. For the example, the power supply line is supplied with electric power from at least one of a power supply apparatus, a power distribution unit, and the information processing apparatus, and the power supply apparatus may be incorporated in the information processing apparatus.

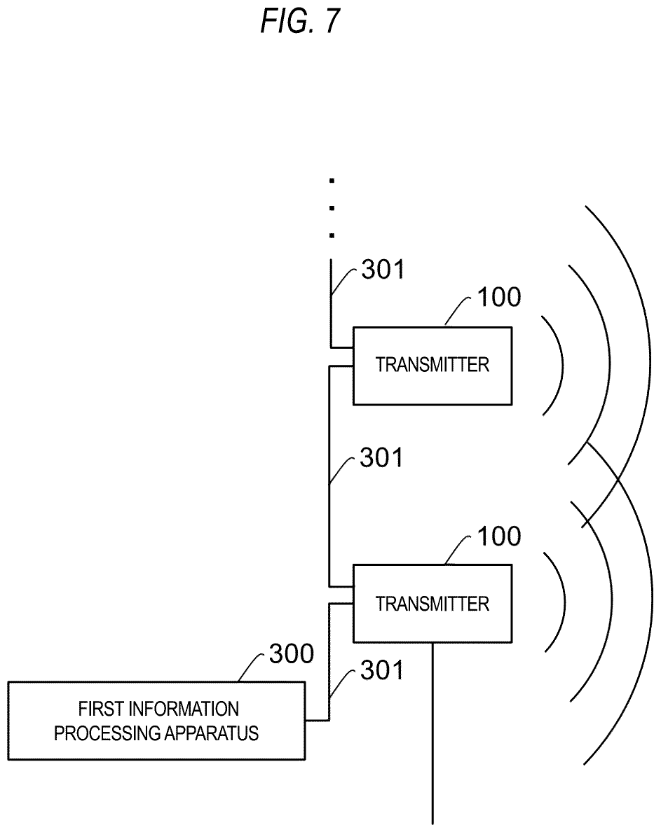

FIG. 7 is a block diagram illustrating another example configuration when the first information processing apparatus 300 and the transmitter 100 are connected. In the example shown in FIG. 7, the power supply line is connected to a first transmitter 100 that is daisy-chained, and electric power is supplied.

In the above embodiment, cases are described in which electric power and a data signal are transmitted by a single cable and in which electric power, a data signal, and a reference signal are transmitted by a single cable. However, a cable that transmits a signal to the transmitters 100 that are daisy-chained is not limited to a single cable. For example, a cable that transmits electric power among the transmitters 100 that are daisy-chained and a cable that transmits a data signal among the transmitters 100 that are daisy-chained may be separate cables. In addition, a cable that transmits a reference signal among the transmitters 100 that are daisy-chained may be a cable different from the cable for transmitting electric power and the cable for transmitting a data signal.

### <3 Basic Hardware Configuration of Computer>

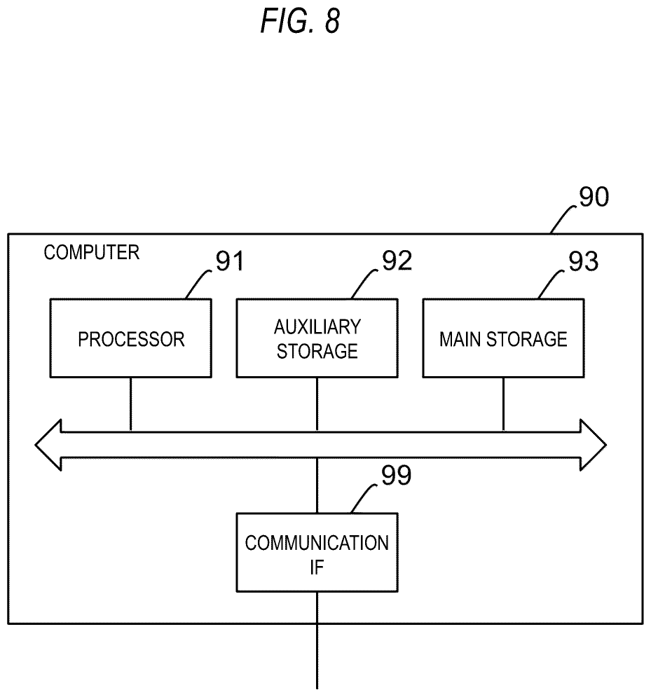

FIG. 8 is a block diagram illustrating a basic hardware configuration of a computer 90. The computer 90 includes at least a processor 91, a main storage 92, an auxiliary storage 93, and a communication interface (IF) 99. These are electrically connected to each other by a bus.

The processor 91 is hardware for executing an instruction set described in a program. The processor 91 is constituted by an arithmetic unit, registers, peripheral circuits, and the like.

The main storage 92 is for temporarily storing a program and data processed by the program and the like. For example, it is a volatile memory such as DRAM (Dynamic Random Access Memory).

The auxiliary storage 93 is a storage device for storing data and programs. Examples include a flash memory, an HDD (Hard Disk Drive), a magneto-optical disk, a CD-ROM, a DVD-ROM, and a semiconductor memory.

The communication IF 99 is an interface for inputting and outputting signals for communicating with another computer via a network using a wired or wireless communication standard.

The network is constituted by, for example, the Internet, a LAN, and various mobile communication systems constructed by wireless base stations. Examples of the network include a 3G/4G/5G mobile communication system, LTE (Long Term Evolution), and a wireless network connectable to the Internet by a predetermined access point (for example, Wi-Fi (registered trademark)). When connected wirelessly, examples of communication protocols include Z-Wave (registered trademark), ZigBee (registered trademark), and Bluetooth (registered trademark). When connected by wire, the network also includes a configuration directly connected by, for example, a USB (Universal Serial Bus) cable.

All or part of the hardware configurations may be provided in a distributed manner among a plurality of computers 90 and mutually connected via a network, thereby virtually implementing the computer 90. Thus, the computer 90 is a concept including not only a computer 90 housed in a single housing or case but also a virtualized computer system.

### <Basic Functional Configuration of Computer 90>

Functions of the computer realized by the basic hardware configuration of the computer 90 illustrated in FIG. 8 will be described. The computer includes at least functional units of a control unit, a storage unit, and a communication unit.

Functional units included in the computer 90 can be realized even when all or part of the respective functional units are provided in a distributed manner among a plurality of computers 90 mutually connected via a network. The computer 90 is a concept including not only a single computer 90 but also a virtualized computer system.

The control unit is realized by the processor 91 reading various programs stored in the auxiliary storage 93, deploying them in the main storage 92, and executing processing in accordance with the programs. The control unit can realize functional units that perform various kinds of information processing in accordance with types of programs. Thus, the computer is realized as an information processing apparatus that performs information processing.

The storage unit is realized by the main storage 92 and the auxiliary storage 93. The storage unit stores data, various programs, and various databases. The processor 91 can secure, in accordance with a program, a storage area corresponding to the storage unit in the main storage 92 or the auxiliary storage 93. The control unit can cause the processor 91, in accordance with various programs, to execute addition, update, and deletion processing of data stored in the storage unit.

A database refers to a relational database and is for managing, in association with each other, data sets called tables that are structurally defined in tabular form by rows and columns. In the database, a table is called a “table,” a column of a table is called a “column,” and a row of a table is called a “record.” In a relational database, relationships between tables can be set and associated.

Usually, a column serving as a key to uniquely identify a record is set in each table, but setting a key for a column is not mandatory. The control unit can cause the processor 91, in accordance with various programs, to execute addition, deletion, and update of records to a specific table stored in the storage unit.

The communication unit is realized by the communication IF 99. The communication unit implements a function of communicating with another computer 90 via a network. The communication unit can receive information transmitted from another computer 90 and input the information to the control unit. The control unit can cause the processor 91, in accordance with various programs, to execute information processing on the received information. The communication unit can also transmit information output from the control unit to another computer 90.

Although several embodiments of the present disclosure have been described above, these embodiments can be implemented in various other forms, and various omissions, substitutions, and changes can be made without departing from the gist of the invention. These embodiments and their modifications are included in the scope and gist of the invention and are also intended to be included in the scope of equivalents of the invention described in the claims.

In the above description, the “processor” is one or more processors. At least one processor is typically a microprocessor such as a CPU (Central Processing Unit), but may be another type of processor such as a GPU (Graphics Processing Unit). At least one processor may be single-core or multi-core.

At least one processor may be a processor in a broad sense, such as a hardware circuit that performs part or all of processing (for example, an FPGA (Field-Programmable Gate Array) or an ASIC (Application Specific Integrated Circuit)).

In the above description, information for which an output is obtained for an input may be described by an expression such as an “xxx table,” but this information may be data of any structure, or may be a learning model such as a neural network that generates an output for an input. Therefore, an “xxx table” can be referred to as “xxx information.”

In the above description, configurations of respective tables are merely examples, and one table may be divided into two or more tables, and all or part of two or more tables may be one table.

In the above description, processing may be described with “program” as a subject; however, since a program performs prescribed processing by being executed by the processor while appropriately using, for example, the storage unit and/or an interface unit, the subject of the processing may be the processor (or a device having the processor, such as a controller or a microcontroller).

A program may be installed in a device such as a computer, or may reside in, for example, a program distribution server or a computer-readable (for example, non-transitory) recording medium. In the following description, two or more programs may be implemented as one program, and one program may be implemented as two or more programs.

In the above description, identification numbers are used as identification information for various targets, but identification information of types other than identification numbers (for example, identifiers including letters or symbols) may be adopted.

In the above description, when elements of the same kind are described without distinction, a reference sign (or a common one of reference signs) is used, and when elements of the same kind are described distinguishingly, an identification number (or a reference sign) of the element may be used.

In the following description, control lines and information lines that are considered necessary for description are shown, and it is not necessarily the case that all control lines and information lines in a product are shown. All configurations may be mutually connected.

### Additional Notes

The matters described in each of the above embodiments are additionally described below.

### (Note 1)

A system comprising: a plurality of transmitters configured to transmit a wireless signal for supplying power; and an information processing apparatus configured to supply electric power for transmitting the wireless signal; in which the plurality of transmitters are electrically in series with the information processing apparatus in a daisy-chain connection, in which at least one transmitter among the plurality of transmitters comprises a measurement unit configured to measure at least one of a voltage and a current associated with the supply of the electric power, in which at least one of (i) a transmitter among the plurality of transmitters or (ii) the information processing apparatus comprises a determination unit configured to determine whether at least one of the measured voltage and the measured current satisfies predetermined requirements, and in which at least one of (i) a transmitter among the plurality of transmitters or (ii) the information processing apparatus comprises notification unit configured to, when the predetermined requirements are not satisfied, notify information regarding a determination result to at least one of a user and the information processing apparatus.

### (Note 2)

The system according to claim 1, in which at least one transmitter among the plurality of transmitters is connected to the information processing apparatus and to another transmitter, is configured to receive electric power supplied from the information processing apparatus, and is configured to supply at least a portion of the received electric power to the other transmitter to which it is connected; and in which at least one transmitter among the plurality of transmitters is connected in a daisy-chain among the transmitters, is configured to receive electric power supplied from an upstream transmitter, and is configured to supply at least a portion of the received electric power to a downstream transmitter.

### (Note 3)

The system according to claim 2, in which at least one transmitter among the plurality of transmitters is configured to transmit the wireless signal by using a portion of electric power supplied from the information processing apparatus or from the upstream transmitter, and to supply at least a portion of remaining electric power to the downstream transmitter.

### (Note 4)

The system according to claim 2, in which at least one transmitter among the plurality of transmitters that is connected at an end of the daisy-chain includes a termination resistor.

### (Note 5)

The system according to claim 1, in which at least two transmitters among the plurality of transmitters are each connected to the information processing apparatus and to another transmitter, are configured to receive electric power supplied from the information processing apparatus, and are configured to supply at least a portion of the received electric power to the other transmitter to which they are connected.

### (Note 6)

The system according to claim 1, in which the determining is performed by at least one transmitter among the plurality of transmitters.

### (Note 7)

The system according to claim 1, in which at least one transmitter among the plurality of transmitters is configured to notify the information processing apparatus of information regarding at least one of the measured voltage and the measured current, and the information processing apparatus comprises a determination unit configured to determine, based on the information, whether at least one of a supply voltage and a supply current of electric power supplied to the respective transmitter satisfies predetermined requirements.

### (Note 8)

The system according to claim 1, in which the information processing apparatus is configured to transmit, to a connected transmitter, a frequency reference signal to cause the wireless signal to be generated at a predetermined frequency, and at least one transmitter among the plurality of transmitters is configured, via the series connection, to transmit the frequency reference signal supplied from at least one of the information processing apparatus and an upstream transmitter to a downstream transmitter.

### (Note 9)

The system according to claim 8, in which at least one of the information processing apparatus and at least one transmitter of the transmitters is configured to transmit the electric power and the frequency reference signal over a single cable.

### (Note 10)

The system according to claim 1, in which the information processing apparatus is configured to transmit, to a connected transmitter, a data signal including predetermined information, and at least one transmitter among the plurality of transmitters is configured, via the series connection, to transmit the data signal supplied from at least one of the information processing apparatus and an upstream transmitter to a downstream transmitter.

### (Note 11)

The system according to claim 10, in which at least one of the information processing apparatus and a transmitter is configured to transmit the electric power and the data signal over a single cable.

### (Note 12)

The system according to claim 8, in which the information processing apparatus is configured to transmit, to a connected transmitter, a data signal including predetermined information, at least one transmitter among the plurality of transmitters is configured, via the series connection, to transmit the data signal supplied from at least one of the information processing apparatus and an upstream transmitter to a downstream transmitter, and at least one of the information processing apparatus and a transmitter is configured to transmit the electric power, the frequency reference signal, and the data signal over a single cable.

### (Note 13)

A transmitter configured to be connected electrically in series in a daisy-chain with at least one other transmitter and with an information processing apparatus that supplies electric power for transmitting a wireless signal for supplying power, the transmitter comprising: a measurement unit configured to measure at least one of a voltage and a current associated with the supplied electric power; a determination unit configured to determine whether at least one of the measured voltage and the measured current satisfies predetermined requirements; and
notification unit configure to, when the predetermined requirements are not satisfied, notify information regarding a determination result to at least one of a user and an information processing apparatus.

### (Note 14)

The transmitter according to claim 13, in which the transmitter is configured to supply at least a portion of received electric power to a downstream transmitter.

### (Note 15)

The transmitter according to claim 13, in which the transmitter includes a termination resistor for use when the transmitter is employed at an end of a daisy-chain.

### (Note 16)

A method of operating a system including a plurality of transmitters and an information processing apparatus, the method comprising: supplying, by the information processing apparatus, electric power to the plurality of transmitters that are electrically in series with the information processing apparatus; transmitting, by at least one transmitter among the plurality of transmitters, the wireless signal for supplying power by using a portion of supplied electric power and supplying at least a portion of remaining electric power to a downstream transmitter; measuring, by at least one transmitter among the plurality of transmitters, at least one of a supply voltage and a supply current; determining, by at least one of (i) a transmitter among the plurality of transmitters or (ii) the information processing apparatus, whether at least one of the measured voltage and the measured current satisfies predetermined requirements; and when the predetermined requirements are not satisfied, notifying information regarding a determination result to at least one of a user and the information processing apparatus.

### (Note 17)

The method according to claim 16, in which the determining is performed by at least one transmitter among the plurality of transmitters.

### (Note 18)

The method according to claim 16, in which the determining is performed by the information processing apparatus.

### (Note 19)

The method according to claim 16, in which the information processing apparatus transmits a frequency reference signal and/or a data signal to a transmitter, and at least one transmitter among the plurality of transmitters relays the signal downstream via the series connection.

### (Note 20)

The method according to claim 19, in which at least one of the information processing apparatus and a transmitter transmits the electric power and at least one of the frequency reference signal and the data signal over a single cable.

What is claimed is:

1. A system comprising:
a plurality of transmitters configured to transmit a wireless signal for supplying power; and
an information processing apparatus configured to supply electric power to the plurality of transmitters for transmitting the wireless signal;
wherein the plurality of transmitters are electrically connected in series with the information processing apparatus in a daisy-chain connection,
wherein at least one transmitter among the plurality of transmitters comprises a measurement unit configured to measure at least one of a voltage and a current associated with the supply of the electric power,
wherein at least one of (i) a transmitter among the plurality of transmitters or (ii) the information processing apparatus comprises a determination unit configured to determine whether at least one of the measured voltage and the measured current satisfies a predetermined requirement, and
wherein at least one of (i) a transmitter among the plurality of transmitters or (ii) the information processing apparatus comprises a notification unit configured to, when the predetermined requirement is not satisfied, notify information regarding a determination result to at least one of a user and the information processing apparatus.

2. The system according to claim 1, wherein at least one transmitter among the plurality of transmitters is connected to the information processing apparatus and to another transmitter, is configured to receive electric power supplied from the information processing apparatus, and is configured to supply at least a portion of the received electric power to the other transmitter to which it is connected; and wherein at least one transmitter among the plurality of transmitters is connected in a daisy-chain among the transmitters, is configured to receive electric power supplied from an upstream transmitter, and is configured to supply at least a portion of the received electric power to a downstream transmitter.

3. The system according to claim 2, wherein at least one transmitter among the plurality of transmitters is configured to transmit the wireless signal by using a portion of electric power supplied from the information processing apparatus or from the upstream transmitter, and to supply at least a portion of remaining electric power to the downstream transmitter.

4. The system according to claim 2, wherein at least one transmitter among the plurality of transmitters that is connected at an end of the daisy-chain includes a termination resistor.

5. The system according to claim 1, wherein at least two transmitters among the plurality of transmitters are each connected to the information processing apparatus and to another transmitter, are configured to receive electric power supplied from the information processing apparatus, and are configured to supply at least a portion of the received electric power to the other transmitter to which they are connected.

6. The system according to claim 1, wherein the determining is performed by at least one transmitter among the plurality of transmitters.

7. The system according to claim 1, wherein at least one transmitter among the plurality of transmitters is configured to notify the information processing apparatus of information regarding at least one of the measured voltage and the measured current, and the information processing apparatus comprises the determination unit configured to determine, based on the information, whether at least one of a supply voltage and a supply current of electric power supplied to the respective transmitter satisfies predetermined requirements.

8. The system according to claim 1, wherein the information processing apparatus is configured to transmit, to a connected transmitter, a frequency reference signal to cause the wireless signal to be generated at a predetermined frequency, and at least one transmitter among the plurality of transmitters is configured, via the series connection, to transmit the frequency reference signal supplied from at least one of the information processing apparatus and an upstream transmitter to a downstream transmitter.

9. The system according to claim 8, wherein at least one of the information processing apparatus and at least one transmitter of the transmitters is configured to transmit the electric power and the frequency reference signal over a single cable.

10. The system according to claim 1, wherein the information processing apparatus is configured to transmit, to a connected transmitter, a data signal including predetermined information, and at least one transmitter among the plurality of transmitters is configured, via the series connection, to transmit the data signal supplied from at least one of the information processing apparatus and an upstream transmitter to a downstream transmitter.

11. The system according to claim 10, wherein at least one of the information processing apparatus and a transmitter is configured to transmit the electric power and the data signal over a single cable.

12. The system according to claim 8, wherein the information processing apparatus is configured to transmit, to a connected transmitter, a data signal including predetermined information, at least one transmitter among the plurality of transmitters is configured, via the series connection, to transmit the data signal supplied from at least one of the information processing apparatus and an upstream transmitter to a downstream transmitter, and at least one of the information processing apparatus and a transmitter is configured to transmit the electric power, the frequency reference signal, and the data signal over a single cable.

13. A transmitter configured to be connected electrically in series in a daisy-chain with at least one other transmitter and with an information processing apparatus configured to supply electric power for transmitting a wireless signal for supplying power, the transmitter comprising:
a measurement unit configured to measure at least one of a voltage and a current associated with the supplied electric power;
a determination unit configured to determine whether at least one of the measured voltage and the measured current satisfies a predetermined requirement; and
a notification unit configured to, when the predetermined requirement is not satisfied, notify information regarding a determination result to at least one of a user and the information processing apparatus.

14. The transmitter according to claim 13, wherein the transmitter is configured to supply at least a portion of received electric power to a downstream transmitter.

15. The transmitter according to claim 13, wherein the transmitter includes a termination resistor for use when the transmitter is employed at an end of a daisy-chain.

16. A method of operating a system including a plurality of transmitters and an information processing apparatus, the method comprising:
supplying, by the information processing apparatus, electric power to the plurality of transmitters that are electrically connected in series with the information processing apparatus;
transmitting, by at least one transmitter among the plurality of transmitters, the wireless signal for supplying power by using a portion of supplied electric power and supplying at least a portion of remaining electric power to a downstream transmitter;
measuring, by at least one transmitter among the plurality of transmitters, at least one of a supply voltage and a supply current associated with the supply of the electric power;
determining, by at least one of (i) a transmitter among the plurality of transmitters or (ii) the information processing apparatus, whether at least one of the measured voltage and the measured current satisfies a predetermined requirement; and
when the predetermined requirements are not satisfied, notifying information regarding a determination result to at least one of a user and the information processing apparatus.

17. The method according to claim 16, wherein the determining is performed by at least one transmitter among the plurality of transmitters.

18. The method according to claim 16, wherein the determining is performed by the information processing apparatus.

19. The method according to claim 16, wherein the information processing apparatus transmits a frequency reference signal and/or a data signal to a transmitter, and at least one transmitter among the plurality of transmitters relays the signal downstream via the series connection.

20. The method according to claim 19, wherein at least one of the information processing apparatus and a transmitter transmits the electric power and at least one of the frequency reference signal and the data signal over a single cable.
